(19) United States
(12) Patent Application Publication
(10) Pub. No.: US 2024/0116391 A1
(43) Pub. Date: Apr. 11, 2024

(54) METHOD AND SYSTEM FOR CONTROLLING AN AMOUNT OF CHARGING RESOURCES AVAILABLE TO A PLURALITY OF ELECTRIC VEHICLE SUPPLY EQUIPMENTS

(71) Applicant: GreenFlux Assets B.V., Amsterdam (NL)

(72) Inventors: Lennart Frans VERHEIJEN, Amsterdam (NL); Max Emile VAN DER LEEST, Amsterdam (NL)

(73) Assignee: c/o GreenFlux Assets B.V., Amsterdam (NL)

(21) Appl. No.: 18/002,546

(22) PCT Filed: Jul. 7, 2022
(86) PCT No.: PCT/EP2022/068900

§ 371 Date: Dec. 20, 2022

(30) Foreign Application Priority Data
Jul. 7, 2021 (NL) 2028655

(51) Int. Cl. B60L 53/67; B60L 53/62; B60L 53/63; H02J 3/00; H02J 3/32

(52) U.S. Cl. CPC B60L 53/67; B60L 53/62; B60L 53/63; H02J 3/003; H02J 3/322

(57) ABSTRACT

A method is disclosed for controlling an amount of charging resources available to a plurality of electric vehicle supply equipments, EVSEs. The method comprises receiving, from each of the plurality of EVSEs, data representing one or more actual charging profiles of respective one or more charging sessions. Each actual charging profile indicates for its charging session a plurality of values indicative of an amount of consumed charging resources at respective times ranging from an actual charging session start time to an actual charging session end time. Further, each actual charging profile is indicative of a total amount of energy provided to an electric vehicle during the charging session associated with the actual charging profile. The method further comprises, for each actual charging profile, determining a fictitious charging profile associated with a fictitious charging session based on the actual charging profile. The fictitious charging profile being indicative of the total amount of energy provided during the charging session associated with the actual charging profile in question. Also, the fictitious charging profile is indicative of an amount of fictitious consumed charging resources at respective times during the fictitious charging session ranging from a fictitious charging session start time to a fictitious charging session end time. At least one fictitious charging session is shorter than the actual charging session. The method also comprises, based on the determined fictitious charging profiles, predicting a total amount of required charging resources at a future time for the plurality of EVSEs.

### FIELD OF THE INVENTION

This disclosure relates to a method for controlling an amount of charging resources available to a plurality of electric vehicle supply equipments, in particular to such a method that involves determining fictitious charging profiles based on respective actual charging profiles. This disclosure further relates to a data processing system, computer program and computer-readable storage medium for performing this method.

### BACKGROUND

In a typical electrical power distribution network, a relatively small number of power supplying companies provide the electrical power to the network. The power distribution network, also referred to as the “grid”, distributes the electrical power to relatively many consumers, such as households and factories. It is very important that at any given time the amount of electrical power that is fed into the grid by energy producers equals the amount of electrical power that is consumed by all consumers that are connected to the grid. If this is not the case, then, due to safety measures, power plants may disconnect from the grid and/or shut down, which may cause a black-out of the grid. Of course, this is highly undesired. To prevent such black-outs, so-called grid balancing has to be performed. Such grid balancing may involve causing an increase or decrease in energy production during a certain time period so that more or less power is going to be provided to the power distribution network. Such grid balancing may also involve managing the consumption of electrical energy by consumers connected to the network, for example through agreements with high volume consumers.

It has already been recognized, see for example Guille and Gross, A conceptual framework for the vehicle-to-grid (V2G) implementation, Energy Policy 37 (2009) 4379-4390 (hereinafter referred to as “Guille”), that batteries of electric vehicles (EVs) can play an important role in maintaining reliable operations of the grid. When many EVs are connected to the grid, they together form a significant generation/storage device that can be used to provide electrical power to the grid if the grid experiences a deficiency of electrical power, and to absorb (additional) electrical power from the grid if the grid has a surplus of electrical power. Such a generation/storage device is especially useful in case numerous alternative energy sources, such as wind turbines and solar panels are connected to the grid, since their energy production may vary significantly and unpredictably. A collection of EVs connected to the grid is sometimes also referred to as a virtual power plant (VPP).

Eventually, of course, EVs need to be net consumers of electrical power since their batteries need to be charged so that the EVs can actually drive around. Hence, a VPP formed by EVs is a net consumer of electrical power. The EVs are thus an additional load on the power distribution network, however, one that is controllable. Balance Responsible Parties (BRP), which are the parties that hold a portfolio of energy consumers and/or producers and that are responsible for balancing their own portfolio, must accurately forecast how much electrical power they require for future time periods. These predictions are used in order to know how much energy should be produced/purchased by the BRP. The total expected power volume per time-instance (PTU) and/or imbalance settlement period (ISP) is also communicated to the Transmission System Operator (TSO), which is the party that is responsible for balancing the grid which the BRPs use.

Such predictions are typically made based on historical power consumption figures. As such, the expected consumption of a VPP formed by EVs can be determined based on historical consumption of energy by the VPP. However, accurately forecasting the power consumption based on such historical power consumption becomes problematic if the historical power consumption of the VPP was actively managed. It may for example be that the power consumption of the VPP during the last few days was actively lowered because other loads on the grid required unexpectedly large amounts of power during these last few days.

In any case, when the power consumption of the VPP has been actively managed, e.g. actively lowered, during some time period, then the consumption of the VPP during this time period does not accurately reflect the true, ‘originally desired’ power consumption of the VPP during this time period. This ‘originally desired’ power consumption is in fact the amount of power that would have been consumed were it not that the power consumption was actively managed. This ‘originally desired’ power consumption may also be referred herein to as the “uncontrolled load”. Hence, the historical power consumption figures for this time period are preferably not used for predicting the future power consumption of the VPP. This may namely lead to an incorrect amount of electrical power to be available for the VPP at a future time.

Hence, there is a need in the art for an improved method for controlling an amount of charging resources available to a plurality of electric vehicle supply equipments (EVSEs), which provide electrical power from the power distribution to a plurality of respective EVs.

### SUMMARY

To that end, a method is disclosed for controlling an amount of charging resources available to a plurality of electric vehicle supply equipments, EVSEs. The method comprises receiving, from each of the plurality of EVSEs, data representing one or more actual charging profiles of respective one or more charging sessions. Each actual charging profile indicates for its charging session a plurality of values indicative of an amount of consumed charging resources at respective times ranging from an actual charging session start time to an actual charging session end time. Further, each actual charging profile is indicative of a total amount of energy provided to an electric vehicle during the charging session associated with the actual charging profile. The method further comprises, for each actual charging profile, determining a fictitious charging profile associated with a fictitious charging session based on the actual charging profile. The fictitious charging profile being indicative of the total amount of energy provided during the charging session associated with the actual charging profile in question. Also, the fictitious charging profile is indicative of an amount of fictitious consumed charging resources at respective times during the fictitious charging session ranging from a fictitious charging session start time to a fictitious charging session end time. At least one fictitious charging session is shorter than the actual charging session. Preferably, it holds for the majority of fictitious charging sessions, e.g. for all fictitious charging sessions, that they are shorter than their respective associated actual charging sessions. The method also comprises, based on the determined fictitious charging profiles, predicting a total amount of required charging resources at a future time for the plurality of EVSEs.

This method, which may be a computer-implemented method, enables to appropriately control the amount of charging resources that are available for the plurality of EVSEs through the power distribution network. As explained above, the actual charging profiles may not reflect the actual amount of desired charging resources at a certain time, i.e. may not reflect the amount of charging resources that the EVSE in question could have consumed at the certain time. Predicting future power consumption based on actual charging profiles may thus result in wrong amounts of charging resources, too little or too many, being available at some future time. The fictitious charging profiles do not, or at least to a lesser extent, suffer from this. The fictitious charging profiles are indicative of the same total energy provided during the charging session. However, the fictitious charging sessions are typically shorter than the actual charging sessions. This allows the fictitious charging profiles to be determined such that they more accurately indicate the amount of resources that the EV would have consumed in case no limit was imposed by the EVSE. To illustrate, it may be that an actual charging profile of a charging session indicates that between 12:00-14:00 o'clock the power consumption is at xx kW, that between 14:00-15:00 o'clock the power consumption is at zero kW (due to a limit being imposed) and that between 15:00-16:00 o'clock the power consumption is at xx kW again. In this example, the fictitious charging profile may for example run from 12:00-15:00 o'clock, whereas the charging session ran from 12:00-16:00 o'clock. The fictitious charging session, since it is shorter than the actual charging session, yet is indicative of the same amount of total energy provided during the charging session, better indicates the actually desired amount of charging resources between 12:00-16:00 o'clock. The EV could likely have consumed xx kW from 12:00-15:00 o'clock, were it not that a limit of zero kW was imposed from 15:00-16:00 o'clock. The concept of the fictitious charging session thus, at least to some extent, corrects for the limit that was imposed between 15:00-16:00 o'clock.

Since the fictitious charging profiles can better reflect the actual amount of desired charging resources, also referred to as the uncontrolled load, future required amounts of charging resources can be more accurately predicted, which in turn enables better balancing of the grid. The determined fictitious charging profiles may serve as training data in some machine learning algorithm to predict the required charging resources at a future time. Such prediction may be performed based on the fictitious charging profiles, or on an aggregate fictitious charging profile described below, using methods well-known in the art such as described by Briceno et al (2013). Singular spectrum analysis for forecasting of electric load demand, Chemical Engineering Transactions, 33:919-924; and Elamin, N. and Fukushige, M. (2018), Modeling and forecasting hourly electricity demand by sarimax with interactions, Energy, 165; and Shepero, M. (2018). Modeling and forecasting the load in the future electricity grid: Spatial electric vehicle load modeling and residential load forecasting. PhD thesis.

The charging profiles that are received from the plurality of EVSEs may indicate actually measured values of charging resources, such as amperes, provided at respective times. These values may have been measured by the EVSE.

The actual charging session start time may be the time at which an EV connects to an EVSE for charging and the actual charging session end time may be the time at which the battery of the EV has been fully charged and/or at which the EV disconnects from the EVSE.

As used herein, an amount of charging resources may be understood to refer to an amount of electrical power and/or to an amount of current (provided at some, optionally fixed, voltage) and/or amount of electrical energy and/or amount of amperes. During a charging session, the amount of electrical power that is provided may vary with time.

In an embodiment, the method comprises providing the total amount of required charging to the plurality of EVSEs at the future time.

In an embodiment, the step of causing the predicted total amount of required charging resources to be available for the plurality of EVSEs at the future time comprises controlling a charging resource provisioning system, such as a power plant, that is connected to the grid in such that the predicted total amount of required charging resources is indeed available for the plurality of EVSEs at the future time. Such control of a charging resource provisioning system may comprise increasing or decreasing electrical power production, for example by controlling an operation frequency of an electrical power generator of a power plant. Additionally or alternatively, the step of causing the predicted total amount of required charging resources to be available for the plurality of EVSEs at the future time comprises controlling a charging resource consuming system connected to the grid such that the predicted total amount of required charging resources is indeed available for the plurality of EVSEs at the future time. Such control of a charging resource consuming system may comprise decreasing or increasing the consumption rate of electrical power by the charging resource consuming system at the future time, to match less controllable power production units like solar panels or wind power.

The method also optionally comprises causing said predicted total amount of required charging resources to be available for the plurality of EVSEs at the future time. This latter step may be understood as that the predicted total amount of required charging resources has been reserved for the plurality of EVSEs so that they are available at the future time for the plurality of EVSEs.

In an embodiment, causing the predicted total amount of required charging resources to be available for the plurality of EVSEs at the future time comprises sending a request for the predicted total amount of charging resources to a balance responsible party and/or energy supplier, in particular to data processing systems of these parties. This embodiment provides a convenient manner for causing that the predicted total amount of charging resources will be available for the plurality of EVSEs at the future time. Sending such request may be embodied by simply sending the predicted total amount of required charging resources to the balance responsible party and/or energy supplier.

In an embodiment, the step of predicting, based on the determined fictitious charging profiles, a total amount of required charging resources at a future time for the plurality of EVSEs comprises
based on the determined fictitious charging profiles, determining an aggregate fictitious charging profile, and
based on the aggregate fictitious charging profile, predicting said total amount of required charging resources at a future time for a plurality of EVSEs.

This embodiment enables to accurately forecast the required amount of charging resources for the plurality of EVSEs.

In an embodiment, determining the aggregate charging profile based on the fictitious charging profiles comprises determining, for each time out of a plurality of times, a sum of values that are indicated by the respective fictitious charging profiles for that time. This embodiment provides a straightforward and convenient manner for determining the aggregate charging profile.

In an embodiment, said at least one fictitious charging profile indicates a substantially constant value indicative of a fictitious amount of consumed charging resources during the fictitious charging session. Preferably, each fictitious charging profile indicates a substantially constant value indicative of a fictitious amount of consumed charging resources during the fictitious charging session. This embodiment enables to accurately determine appropriate fictitious charging profiles.

In an embodiment, the substantially constant value is substantially equal to a maximum value out of said plurality of values indicated by the actual charging profile in question.

In an embodiment, each EVSE is suitable for imposing a limit on the amount of charging resources that it provides to an electric vehicle charging with it. In such embodiment, for each actual charging profile, the substantially constant value referred to above may be substantially equal to a value out of said plurality of values which indicates an amount of consumed charging resources at a time at which the EVSE did not impose a limit on the amount of charging resources that it provides.

This embodiment is advantageous in that the amount of consumed charging resources that an EVSE consumes when no limit is imposed on it indicates the likely preferred charging rate of the electric vehicle on that EVSE. This provides information on what the actual charging profile would look like if no limit is imposed. A relatively safe assumption is that the electric vehicle will continue charging at his preferred charging rate until this batteries are fully charged, after which the charging rate will drop relatively sharply.

It should be appreciated that each EVSE may be suitable for imposing a limit on the amount of charging resources that it provides to an electric vehicle charging with it, wherein the imposed limit is lower than an amount of charging resources that the hardware of the EVSE can maximally handle. Thus, the limit may be understood to be actively imposed, e.g. using a data processing system, as opposed to be defined by the hardware of the EVSE.

In an embodiment, the method comprises controlling each of the plurality of EVSEs during its actual charging session such that the EVSE in question, for at least some time period, such as for at least two minutes, provides charging resources to an electric vehicle without imposing, a limit on the amount of charging resources that the EVSE in question can provide to the electric vehicle. This may be performed by imposing a very high limit that the EVSE will certainly not reach and/or by imposing a limit equal to the amount of charging resources that the EVSE in question can maximally provide to an electric vehicle. The latter amount may be determined by the hardware components of the EVSE.

It should be appreciated that actively imposing a limit on the amount of providable charging resources for an EVSE may be performed programmatically, i.e. using a data processing system, such as the central control system described below, and/or using a computer program.

Note that knowing an electric vehicles charging characteristics alone is not sufficient for determining its preferred charging rate. If for instance a car of a specific type and brand can charge with 22 kW and is charging on a single phase charge station of which the maximum charge rate is set as a fixed value of 28 A, then this car at this specific charge station has a preferred charging power of 28 A*230V/1000=6.44 kW. If you would take the same car and the same charge station to a USA split phase household connection, the preferred charging power would be 28 A*110V/1000=3.08 kW. If the car charges at a 63 kW AC fast charger, the car will have a preferred charging power of 22 kW (its maximum). If the car charges at a 63 kW AC fast charger, but when the session starts already has a state of charge of 97%, the preferred charging power will be lower than 22 kW. This example shows that the preferred charging power is relative to the type of vehicle and the specific charge station and has to be determined on a per session basis, for example by letting the electric vehicle charge freely for some time period.

In an embodiment, a length of the fictitious charging session, said length being a difference between the fictitious charging session start time and fictitious charging session end time, is substantially equal to a ratio between (i) the total amount of energy provided during the charging session and (ii) said substantially constant value.

To illustrate, if the total amount of energy provided during the charging session, i.e. the charging session having the actual charging profile based on which the fictitious charging profile is determined, is indicated by E_total, e.g. in Joule, and the substantially constant value indicative of a fictitious amount of consumed charging resources during the fictitious charging session by P_preferred, e.g. in W, then the length, e.g. in seconds, of the fictitious charging session may be given by

t_charging=E_total/P_preferred.

In an embodiment, the fictitious charging session start time and the actual charging session start time are substantially the same and/or the fictitious charging session end time and the actual charging session end time are substantially the same and/or the fictitious charging session start time lies between the actual charging session start time and the actual charging session end time and/or the fictitious charging session end time lies between the actual charging session start time and the actual charging session end time. This embodiment provides some flexibility in how the fictitious charging profile and associated actual charging profile are time-positioned relative to each other.

In an embodiment, the method comprises
receiving a request for an amount of charging resources to be provided at the future time, and
based on the request and based on the available charging resource for the plurality of EVSEs at the future time, causing one or more EVSEs to impose a limit on the amount of charging resources that they provide to electric vehicles at the future time.

This embodiment enables the plurality of EVSEs to function as a power generator device, as a VPP, by consuming less charging resources than the amount reserved for them. This will namely free up capacity for other power consumers on the grid. Typically, it would require considerable computing resources and bandwidth resources if the decision of whether or not to impose limits on EVSEs in response to such request were to be based on real-time information, i.e. information indicating the total power consumption of all EVSEs at the current time, given the vast amounts of EVSEs connected to the grid.

The request for the amount of charging resources to be provided at the future time may be understood to be a request for freeing up charging resource capacity for the future time.

The step of causing one or more EVSEs to impose the limit may be performed such that the total amount of charging resources that can maximally be provided to electric vehicles by the plurality of EVSEs at the future time is lower than the predicted total amount (and thus lower than the amount of charging resources that have been reserved for the future time for the plurality of EVSEs). The one or more (additional) limits that are imposed by one or more EVSEs based on the request may be understood to set an upper limit for the total amount of charging resources that can be provided by the plurality of EVSEs to electric vehicles at the future time. This upper limit may replace a previously defined upper limit. The new upper limit, determined based on the received request for the amount of charging resources, is typically lower than the previously defined upper limit. Preferably, the difference between predicted total amount and the new upper limit at the future time is equal to the requested amount of charging resources. However, it is not per se the case that sufficient charging resources are reserved (i.e. have been predicted) at the future time in order to fully meet the requested amount of charging resources. If, in a theoretical situation, all EVSEs will be caused to, at the future time, provide substantially no charging resources to electric vehicles, then the charging resource capacity that is freed up as a result, and that can thus be provided to other charging resource consuming systems on the grid, will be equal to the earlier predicted total amount of required charging resources at the future time for the plurality of EVSEs.

In an embodiment, such embodiment comprises
determining that the requested amount of charging resource is substantially equal to and/or lower than the predicted total amount, and
based on this determination, causing one or more EVSEs to impose a limit on the amount of charging resources that they provide to electric vehicles at the future time.

In an embodiment, the step of causing one or more EVSEs to impose a limit on the amount of charging resources that they provide to electric vehicles at the future time frees up the requested amount of charging resources in said power grid for said future time. This embodiment enables to effectively balance the grid in a straightforward manner.

One aspect of this disclosure relates to a data processing system comprising means for performing any of the method steps described herein.

One aspect of this disclosure relates to a computer program comprising instructions which, when the program is executed by a computer, cause the computer to carry out any of the method steps described herein.

One aspect of this disclosure relates to a non-transitory computer-readable storage medium having stored thereon any of the computer programs described herein.

One aspect of this disclosure relates to a computer comprising a
a computer readable storage medium having computer readable program code embodied therewith, and
a processor, preferably a microprocessor, coupled to the computer readable storage medium, wherein responsive to executing the computer readable program code, the processor is configured to perform any of the method steps described herein.

One aspect of this disclosure relates to a computer program or suite of computer programs comprising at least one software code portion or a computer program product storing at least one software code portion, the software code portion, when run on a computer system, being configured for executing any of the method steps described herein.

One aspect of this disclosure relates to a non-transitory computer-readable storage medium storing at least one software code portion, the software code portion, when executed or processed by a computer, is configured to any of the method steps described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems (e.g. to the existing central control system or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 illustrates a system for providing charging resources to a plurality of electric vehicles;

FIG. 1A illustrates a power distribution grid that may be involved in the method embodiments;

FIG. 2 is a flow chart illustrating a method according to an embodiment;

FIG. 3 is a graph illustrating an allocated charging profile, an actual charging profile and a fictitious charging profile according to an embodiment;

FIG. 4 illustrates an aggregate fictitious charging profile according to an embodiment;

FIGS. 5A & 5B show the amount of charging resources that have been made available for future times using methods according to an embodiment;

FIG. 6 illustrates a data processing system according to an embodiment.

### DETAILED DESCRIPTION OF THE DRAWINGS

In the figures, identical reference numbers indicate identical or similar elements.

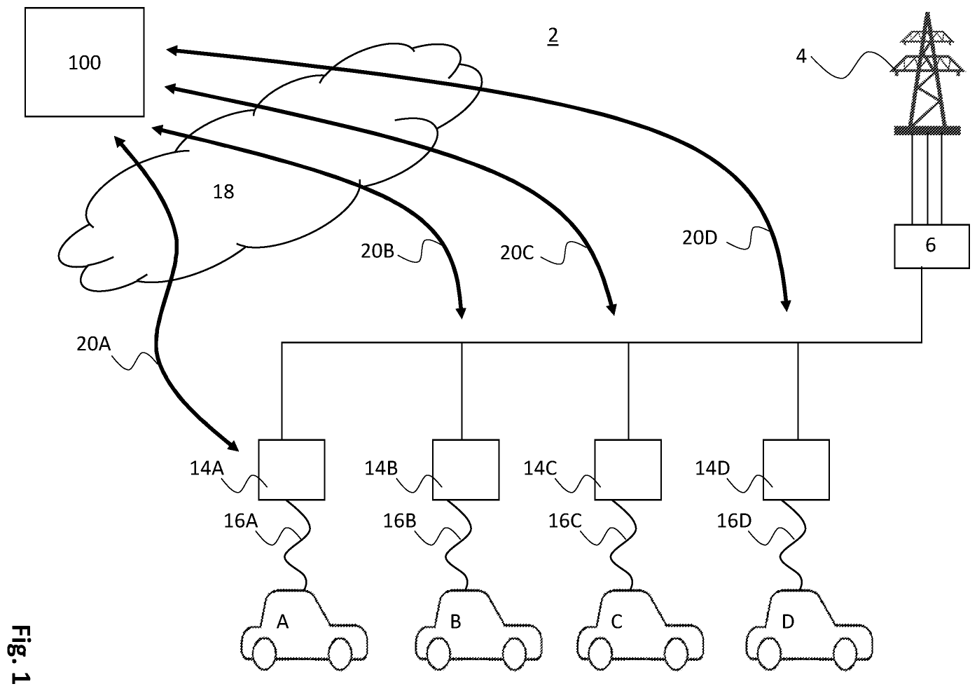

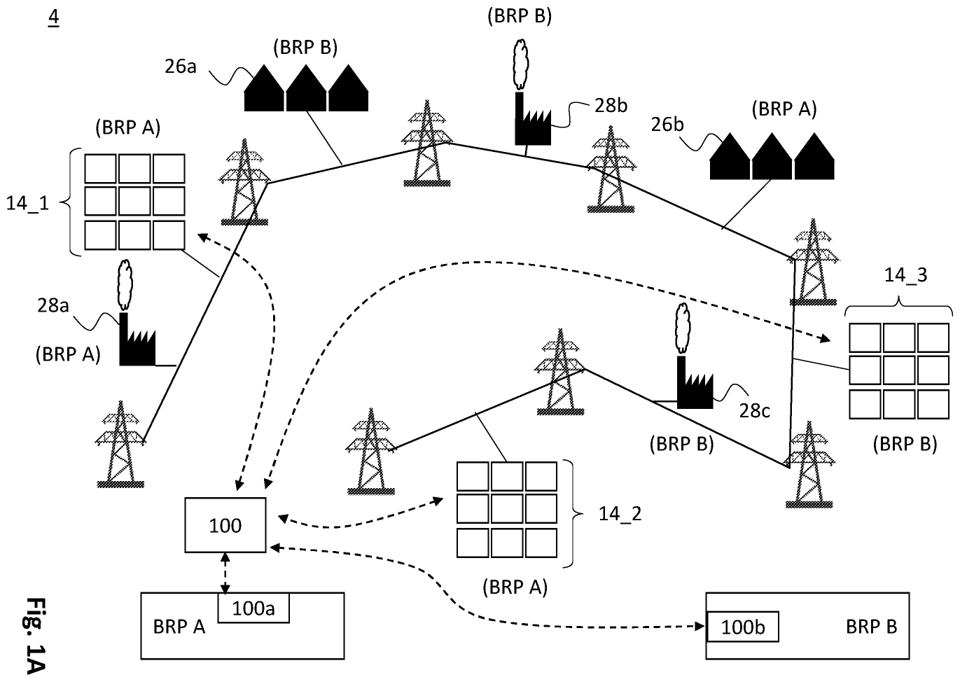

FIG. 1 schematically illustrates a system 2 for providing charging resources to a plurality of electric vehicles, in this example electric vehicles A, B, C and D. The system 2 comprises a central control system 100 and a plurality of EVSEs 14, in this example EVSE 14A, EVSE 14B, EVSE 14C, EVSE 14D. Of course, the system 2 may in principle comprise any number of EVSEs in order to charge any number of electric vehicles.

As used herein, electric vehicle may be understood to relate to any vehicle comprising an electric propulsion motor. Non-limiting examples of electric vehicles are electric cars, electric motorcycles, electric bicycles, electric airplanes and electric ships. An electric propulsion motor converts electrical energy into mechanical energy and therefore an electric vehicle comprises one or more batteries for storing electrical energy. The electric vehicles and EVSEs 14 are configured to electrically connect to each other in order to charge the one or more batteries of the electric vehicles. In FIG. 1, the electric vehicles connect to their respective EVSEs by means of a charging cable 16. Such charging cable 16 may be permanently attached to the EVSE. Alternatively, an electric vehicle carries its own charging cable 16 with it so that the charging cable can be used to connect to an EVSE when the electric vehicle arrives at the EVSE.

As shown, the EVSEs may receive power from a power grid 4, preferably via a converter 6. The power converter 6 is typically configured to convert the incoming power into a form that is suitable for the power distribution system that provides power to the EVSEs 14. Power converter 6 may be configured to perform two conversion steps, one step for converting the high voltage on the power grids 4 to medium voltage and another step for converting medium voltage to low voltage.

The central control system 100 may be configured to communicate with the control system of each EVSE 16 and each control system of each EVSE may be configured to communicate with the central control system 100. To this end, the central control system and control systems of the EVSEs preferably each comprise a communication module that enables such communication, such as a WiFi module.

FIG. 1 indeed shows four communication connections 20A, 20B, 20C, 20D between the central control system 100 and EVSEs 14A, 14B, 14C, 14D respectively. The control system 100 can for example send charging profiles to the EVSEs via these communication connections. Further the control system 100 can receive information from the EVSEs via these connections, such as confirmations of receipt and/or meter values as measured by local meters arranged at the EVSEs. An example of such a local meter would be a meter configured to measure over time how much electrical power an EVSE provides to an electric vehicle. Preferably, such a local meter is configured to perform measurements repeatedly, e.g. periodically, such as once every minute. Likewise, each EVSE can send information to the central control system 100 via the communication connections, such as confirmations of receipt and/or meter values as measured by local meter arranged at the EVSE.

The communication connection 20 may be at least partially wireless. In an example, the plurality of EVSEs are installed at a parking lot and they are wirelessly connected to a central control system that is installed at the parking lot as well. At least part of the central control system may be remote in the sense that it is a remote server, that, in principle, may be positioned anywhere.

In FIG. 1, the EVSEs are connected to the central control system 100 via a network 18, such as the internet.

Central control system 100, which may also be referred to as data processing system 100, may be configured to control an amount of charging resources that can be provided by each EVSE to connected electric vehicles. The control system 100 may be configured to control the amount of charging resources that an EVSE provides by sending to the EVSE a so-called charging profile. Such charging profile then defines a maximum amount that the EVSE in question may provide to its electric vehicle for some time period. The maximum amount may vary over time meaning that at a first time the EVSE may provide at most a first amount of charging resources to its electric vehicle, whereas at a second time, the EVSE may provide at most a second amount of charging resources to its electric vehicle, wherein the first amount and second amount are different. It should be appreciated that the electric vehicle does not necessarily consume this allowed maximum amount of charging resources. It may very well be that the electric vehicle consumes an amount of charging resources that is lower than said maximum amount. The electric vehicles may not be allowed to consume an amount of charging resources that is higher than said amount. If the electric vehicle does consume an amount of charging resources that is higher than said amount, then the EVSE may stop the charge session. Note that such a situation will in general not occur.

The control system of an EVSE may control the amount of charging resources that it provides to an electric vehicle connected to it by communicating to the electric vehicle the maximum amount of charging resources that the electric vehicle may draw from the EVSE, for example in accordance with the methods as described in the IEC61851 standard and/or in the SAE-J1772 standard. Typically, the electric vehicle can control how much charging resources it consumes. The EVSE may subsequently measure the charging resources that it provides to the electric vehicle, for example using an amperemeter. If the (control system of) the EVSE determines that more charging resources are being consumed by the electric vehicle than the communicated maximum amount, the EVSE may be configured to disconnect the electric vehicle from the charging system, e.g. by actuating a power switch.

Such communication between control system of EVSE and electric vehicle may take place over a specific electrical wire (also referred to as the ‘Communication Pilot’) that may be part of the charging cable with which the electric vehicle is connected to the EVSE.

A plurality of EVSEs may form a capacity group. For such a capacity group a capacity group maximum amount of charging resources is defined. The total amount of charging resources that is provided to the capacity group as a whole should never exceed that capacity group maximum amount. Typically, this would result in a failure of the system. Such a failure may involve a circuit breaker tripping. It should be appreciated that the capacity group maximum amount may also vary with time.

An EVSE may be understood to be configured to provide electrical power from power grid 4 to an electric vehicle such that one or more batteries of the electric vehicle are charged. Clearly, if many electric vehicles are connected to the grid 4, then their aggregate power consumption may become significant in that this power consumption should be weighed in the grid balancing that a grid operator, also referred to as a Transmission System Operator (TSO) performs. A TSO is responsible for ensuring that, at any given time, the power that is fed into the power grid 4 is substantially equal to the power that is consumed from the power grid 4. The TSO may be said to be responsible for so-called grid balancing. To this end, the TSO may require so called each Balance Responsible Party (BRP) to ensure that, at any given time, the electrical power providing parties in the BRPs portfolio provide a total amount of electrical power to the power grid 4 that is substantially equal to the electrical power consumed by the power consuming parties in the BRPs portfolio. This means that each BRP should be able to accurately forecast for future times how much charging resources, e.g. electrical power, is required for all power consumers, including the plurality of EVSEs referred to herein. Such forecasts are typically made based on historical data. However, as explained in the Background section, the historical data for a plurality of EVSEs may be distorted if the charging of electric vehicles is actively controlled, for example by a central control system 100 of FIG. 1 sending charging profiles to the EVSEs 14. The methods described herein may be understood to cleanse the historical data and herewith improve the forecasts.

The central control system 100 may be configured to perform the methods described herein for controlling an amount of charging resources available to a plurality of electric vehicle supply equipments, EVSEs, connected to a power grid. The central control system 100 may be understood to control the amount of available resources at a future time by sending an instruction to a BRP that a certain amount of charging resources should be reserved for the plurality of EVSEs. The BRP can then balance its portfolio, e.g. by instructing electrical power provides to provide a certain amount of electrical power at the future time, such that indeed said certain amount of charging resources can be provided from the grid to the EVSEs.

FIG. 1A schematically illustrates a power distribution grid 4 and serves to illustrate how the methods described herein may be regarded as a method for balancing the grid 4. Connected to the grid 4 are electric power consumers 26a and 26b. These may be households, but also industry, et cetera. Also connected to the grid are three sets of EVSEs, namely set 14_1, set 14_2 and set 14_3. These are for example three parking garages having EVSEs installed on site. Also connected to the grid are electric power providers 28a, 28b and 28c. These may be power plants, for example. Further, FIG. 1A indicates that that there are two Balance Responsible Parties, namely BRP A and BRP B.

BRP A has in its portfolio:
set of EVSEs 14_1
set of EVSEs 14_2
power consumers 26b
power providing party 28a.

Further, BRP B has in its portfolio:
power consumers 26a
power providing party 28b
set of EVSEs 14_3
power providing party 28c.

Further, a data processing system 100 according to an embodiment is shown, also referred to as central control system 100 above. The data processing system 100 can receive information from the EVSEs in the sets of EVSEs as indicated by the dashed lines. The data processing system can perform the method described herein and can thus accurately forecast for future times how much electrical power is required for the sets of EVSEs 14a, 14b and 14c. The data processing system can send the forecasts of EVSE sets 14_1 and 14_2 to BRP A, in particular to a data processing system 100a of BRP A, optionally as an aggregate forecast indicating for a future time how much electrical power should be available for EVSE set 14_1 and EVSE set 14_2 together. This is indicated by the dashed line between data processing system 100 and data processing system 100a. Further, the data processing system 100 can send the forecast for EVSE set 14_3 to BRP B, in particular to data processing system 100b of BRP B. This is indicated by the dashed line between data processing system 100 and data processing system 100b of BRP B. These forecasts may be regarded as instructions to the respective BRPs, which instructions cause the forecast amounts of charging resources, e.g. electrical power, to be available at the appropriate future times. Each BRP may namely control the power plants to produce the appropriate amount of electrical power at the future time. Vice versa a BRP may also send instruction to the data processing system 100, indicated by the fact that the dashed line between 100 and 100a/100b is bidirectional, to adjust the power resources consumed by the sets of EVSEs 14a and/or 14b and/or 14c for a future time. Such instructions may be understood to be an example of a request for charging resources to be provided at a future time as described herein. The data processing system 100 may thus receive such request from a data processing system of a BRP.

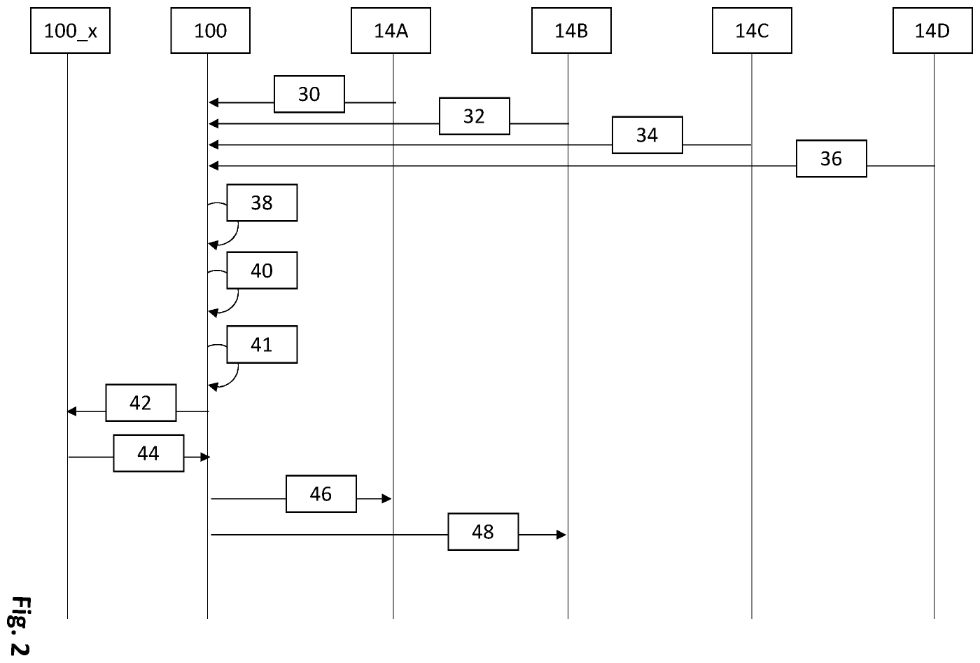

FIG. 2 is a flow chart illustrating a method according to an embodiment. Herein, four EVSEs 14A, 14B, 14C, 14D are shown, as well as data processing system 100, also referred to herein as central control system 100, and another data processing system 100_x. This may be a data processing system of a power plant, for example, or of a BRP, for example.

In steps 30, 32, 34, 36, the EVSEs 14A, 14B, 14C, 14D respectively transmit data to the data processing system 100. The data received from each of the EVSEs may represent one or more actual charging profiles of respective one or more charging sessions. Such charging profile for example indicates the amount of charging resources provided to an electric vehicle versus time. Such charging profile may indicate the amount of charging resources by indicating the amount of electrical power that has actually been provided to an electric vehicle by an EVSE. Additionally or alternatively, such charging profile indicates the amount of charging resources by indicating an amount of current provided to an electric vehicle by an EVSE. Thus, the data processing system 100 receives, from each of the plurality of EVSEs, data representing one or more actual charging profiles of respective one or more charging sessions.

Then, in step 38, the data processing system 100 determines, for each received actual charging profile, a fictitious charging profile described herein associated with a fictitious charging session based on the actual charging profile.

In step 40, the data processing system 100 determines, based on the determined fictitious charging profiles, an aggregate fictitious charging profile.

In step 41, the data processing system 100 predicts, based on the aggregate fictitious charging profile, a total amount of required charging resources at a future time for the plurality of EVSEs, EVSEs 14A, 14B, 14C, 14D in this example. The future time for which the total amount of required charging resources is determined may be a time in the next day or a time in a day a few days ahead, for example.

Once, the total amount of required charging resources has been predicted, the data processing system 100 causes the predicted total amount of required charging resources to be available for the plurality of EVSEs at the future time. In the embodiment of FIG. 2, this involves sending a request in step 42 for the predicted total amount of charging resources to a balance responsible party, in particular to a data processing system 100_x of the balance responsible party. This will allow the balance responsible party to appropriately balance the power supply and demand for the future time. As such, the step of causing the predicted total amount of required charging resources to be available for the plurality of EVSEs at the future time may be understood to be performed by the balance responsible party that receives such request 42. In an example, the balance responsible party may control a power plant to increase power production at the future time. In such case, the step of causing the predicted total amount of required charging resources to be available for the plurality of EVSEs at the future time may be understood to be performed by this power plant as well.

The depicted embodiment also shows further optional steps 44, 46, 48, 50. In step 44, the data processing system 100 receives a request for an amount of charging resources to be provided at the future time. In an example, the BRP of data processing system 100_x, has discovered at some point in time, after it has reserved the predicted total amount at the future time for the plurality of EVSEs, that at the future time not enough electric power is available on its balance to be able to provide all power consumers their predicted amounts. To illustrate, the BRP of data processing system 100_x may be BRP A of FIG. 1A. At some point in time, it may for example receive notice from power plant 28a that power plant 28a will not be able to generate as much power at the future time as it has predicted earlier. Herewith, a disbalance is created at the future time. In response to detecting such disbalance at the future time, the BRP may send a request to control system 100 for an amount of charging resources. Effectively, such request is a request to consume less charging resources at the future time so that the freed up capacity can be provided to other power consumers on the grid.

In the depicted embodiment, based on the request 44 and based on the available charging resource for the plurality of EVSEs at the future time, which is typically equal to the predicted total amount of charging resources for the future time as predicted in step 41, the data processing system causes one or more EVSEs to impose a limit on the amount of charging resources that they provide to electric vehicles at the future time. This may be performed by sending charging profiles setting appropriate maximum amounts of charging resources in steps 46 and 48 to the EVSEs 14A and 14B respectively, as explained with reference to FIG. 1.

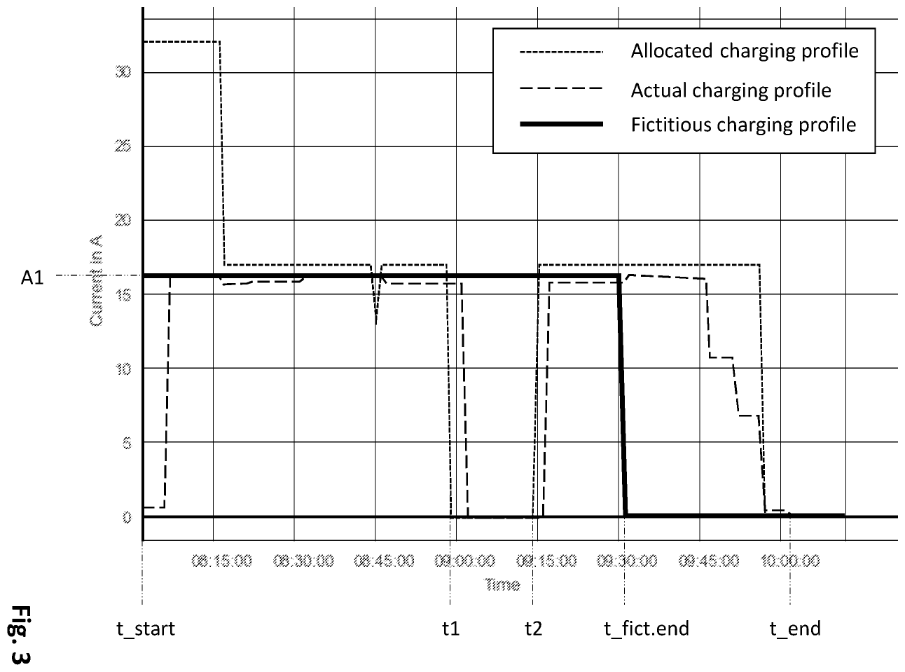

FIG. 3 is a graph illustrating an allocated charging profile (dotted line), an actual charging profile (dashed line) and a fictitious charging profile as described herein that is determined based on the shown actual charging profile.

The allocated charging profile is typically a charging profile that is sent by a central control system described herein to an EVSE. Such allocated charging profile defines for each of a plurality of times the maximum amount of charging resources that the EVSE in question may provide to an electric vehicle at the time in question. As shown, between approximately 6:00 o'clock and 6:15 o'clock, the allocated charging profile is very high. Effectively, this means that no limit is imposed on the EVSE and that it can provide as much charging resources as its hardware can handle and as requested by the electric vehicle.

Further, the allocated charging profile has a zero value between t1 and t2 as indicated. This means that between t1 and t2, the EVSE may not provide any charging resource to its electric vehicle. Such limit may be imposed for any reason. In an example such limit is imposed in response to receiving a request for charging resources as described herein. Such request may be transmitted to the control system 100 by a BRP.

The actual charging profile indicates for the charging session a plurality of values indicative of an amount of consumed charging resources at respective times during the charging session ranging from an actual charging session start time t_start to an actual charging session end time t_end. As shown, during the period in which effectively no limit was imposed on the EVSE as to how much charging resources it can provide to an electric vehicle, i.e. in the time period between approximately 6:00 o'clock and 6:15 o'clock, the maximum amount of provided charging resources is approximately 16 A. In this example, 16 A may be understood to indicate a provided electrical power of 11 kW, assuming that it is provided at a voltage of 230V by means of three phases: 16 A*230V*3=11 kW. Further, it is clearly shown that indeed the charging resources provided by the EVSE drops to substantially zero between t1 and t2. The total energy provided to an electric vehicle can be determined based on the area below the dashed line. The current may namely indicate power in the sense that it indicates the current at some voltage. As known, power multiplied by time yields energy. Thus, the actual charging profile is indicative of a total amount of energy provided to an electric vehicle during the charging session.

Further, the fictitious charging profile also indicates this same total amount of energy provided during the charging session. The area below the solid line is namely equal to the area below the dashed line. Like the actual charging profile, the fictitious charging profile is indicative of an amount of fictitious consumed charging resources at respective times during the fictitious charging session ranging from a fictitious charging session start time to a fictitious charging session end time. In this example, the fictitious charging session start time is indicated by t_start and the fictitious charging session end time is indicated by t_fict.end. As apparent from the figure, the fictitious charging session is shorter than the actual charging session. Because the fictitious charging session is shorter, it better resembles the originally desired electrical power or, in other words, better resembles the power consumption of the electric vehicle if no limit had been imposed on the EVSE during the charging session. This fictitious power consumption may also be referred to as the uncontrolled load. To illustrate, due to the limit imposed between t1 and t2, the EVSE provides charging resources to the electric vehicle between t_fict.end and t_end, whereas this would not have been the case, or at least to a lesser extent, if the limit between t1 and t2 would not have been imposed. If no limit had been imposed, then the one or more batteries of the electric vehicle would have likely reached a fully charged state earlier. Hence, the fictitious charging profile more closely resembles the uncontrolled load.

In the depicted graph, the fictitious charging session end time is such that integrating the fictitious charging profile from the fictitious charging session start time to the fictitious charging session end time yields 100% of the total amount of energy provided to an electric vehicle during the charging session. However, it should be appreciated that the fictitious charging session end time may also be selected such that integrating the fictitious charging profile from the fictitious charging session start time to the fictitious charging session end time yields less than 100% of the total amount of energy provided to an electric vehicle during the charging session, for example yields somewhere between 75% and 100% of the total amount of provided energy. Even if such integration of the fictitious charging profile yields less than 100% of the total energy provided during the charging session, then still the fictitious charging profile, which in principle ranges from the fictitious charging session start time to the fictitious charging session end time, should be understood as indicative for the total energy provided during the charging session.

Further, in this example, the fictitious charging profile indicates a substantially constant value indicative of a fictitious amount of consumed charging resources during the fictitious charging session. This substantially constant value is substantially equal to a maximum value out of said plurality of values indicated by the actual charging profile in question. The fictitious charging profile has a constant value at approximately 16 A. In this example, as explained, the substantially constant value is substantially equal to a value out of said plurality of values which indicates an amount of consumed charging resources at a time at which the EVSE did not impose a limit on the amount of charging resources that it provides.

The fictitious charging profile can be determined based on the actual charging profile by performing the following steps:
setting the fictitious charging start time equal to the actual charging session start time;
determining the total amount of energy provided to the electric vehicle
determining a maximum value out of the plurality of values as indicated by the actual charging profile for the actually provided charging profiles; and
determining the length of the fictitious charging session by determining the ratio between (i) the total amount of energy provided during the charging session and (ii) the determined maximum value;
assuming that the fictitious charging profile has a substantially constant value between the fictitious charging session start time and fictitious charging session end time.

Determining the total amount of energy provided to the electric vehicle may be performed by integrating the actual charging profile. However, typically, each EVSE comprises a local meter that directly measures the total energy provided during the charging session. This value may be communication to the central control system, for example.

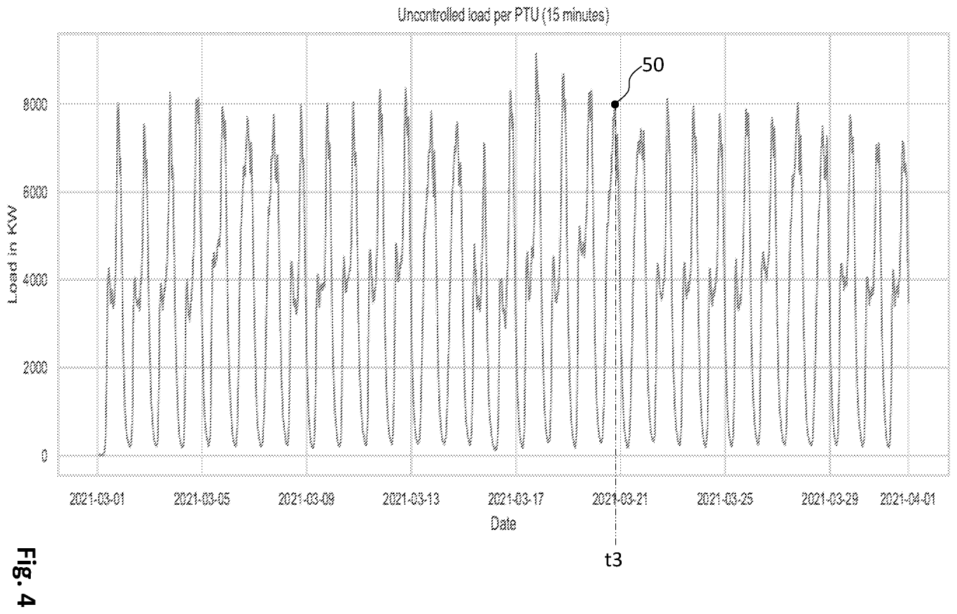

The method comprises determining multiple fictitious charging profiles based on respective multiple actual charging profiles. In an embodiment, the method comprises, based on the determined fictitious charging profiles, determining an aggregate fictitious charging profile. FIG. 4 illustrates such aggregate fictitious charging profile. In this example, it has been determined by determining, for each time out of a plurality of times, a sum of values that are indicated by the respective fictitious charging profiles for that time. To illustrate, the point 50 indicates for time t3 on 20 Mar. 2021 an amount of charging resources, in this example an amount of electrical power of 8000 kW. This point has been determined by summing the amounts of charging resources, in this case the amounts of electrical power, as indicated by 3200 fictitious charging profiles for time t3. Herein, each fictitious charging profile is determined based on an actual charging profile, of course.

Based on the aggregate fictitious charging profile, the total amount of required charging resources at a future time for a plurality of EVSEs may be predicted. Of course, preferably, the required charging resources are determined for a future time period, for example for the next day, coming week, coming month, coming year, et cetera.

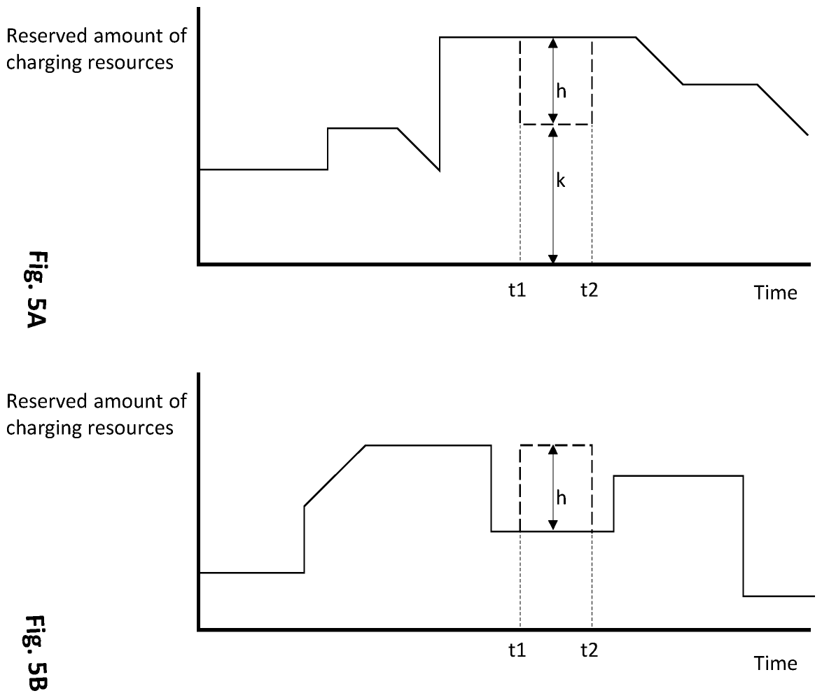

FIGS. 5A and 5B show the amount of charging resources that have been made available for future times using the methods described herein. FIG. 5A shows this for a first plurality of EVSEs belonging to a portfolio of a BRP A, whereas FIG. 5B shows this for a second plurality of EVSEs belonging to a portfolio of a BRP B. At some point in time (not indicated in the figures), BRP B determines that its balance is off between times t1 and t2, for example due to an updated prediction from a large power consumer such as a factory, which updated prediction is h higher between t1 and t2 than originally predicted. In the figures, it is assumed that BRPs balance is off because, unexpectedly, the plurality of EVSEs belonging to BRP B are predicted to consume h more charging resources between t1 and t2 as indicated. In general, unforeseen circumstances in the energy system (e.g. a power plant failing), may be a reason that charging resource consuming systems and/or charging resource provisioning systems, deviate from the initially determined use and/or generation of charging resources, as a result of which theses parties need to update their initial predictions. Thus, BRP B, since it must balance its portfolio, must increase the amount of electrical power available between t1 and t2. For this example, we assume that BRP B cannot control the EVSEs of the second plurality of EVSEs.

Thus, BRP B may (directly, or for example via existing energy markets) send a request to BRP A for h additional charging resources, e.g. electrical power, between t1 and t2. In turn, BRP A may send a request to a central control system 100 described herein for h charging resources to be provided between t1 and t2. The control system may then, based on the received request and based on the available charging resource for the plurality of EVSEs at the future time, cause one or more EVSEs to impose a limit on the amount of charging resources that they provide to electric vehicles at the future time, e.g. in order to free up h electrical power between t1 and t2 as indicated. This may be performed by causing one or more EVSEs in the plurality of EVSEs belonging to BRP A to impose a limit on the amount of charging resources that they can provide to an electric vehicle, such that a total amount of providable charging resources for the plurality of EVSEs is limited at k as indicated The central control system may determine how much capacity it can free up for the time period t1 and t2 based on the amount that has been made available for that time period. Likely this amount that can be freed up is equal to the amount of required charging resources as predicted by the control system earlier. In principle, the control system 100 cannot free up more capacity than the amount that is reserved for the first plurality of EVSEs between t1 and t2. It may be that only part of the request is fulfilled, i.e. that the control system can only limit the EVSEs in the first plurality of EVSEs such that 0.5 h is freed up for BRP B. As a side note, if some of the plurality of EVSEs would be capable of providing charging resources from their batteries to the grid, then more charging resources can be feed up than is reserved for them.

In an embodiment, the control system determines that the requested amount of charging resource is substantially equal to and/or lower than the predicted total amount, and, based on this determination, causing one or more EVSEs to impose a limit on the amount of charging resources that they provide to electric vehicles at the future time, preferably such that it frees up the requested amount of charging resources in said power grid for said future time.

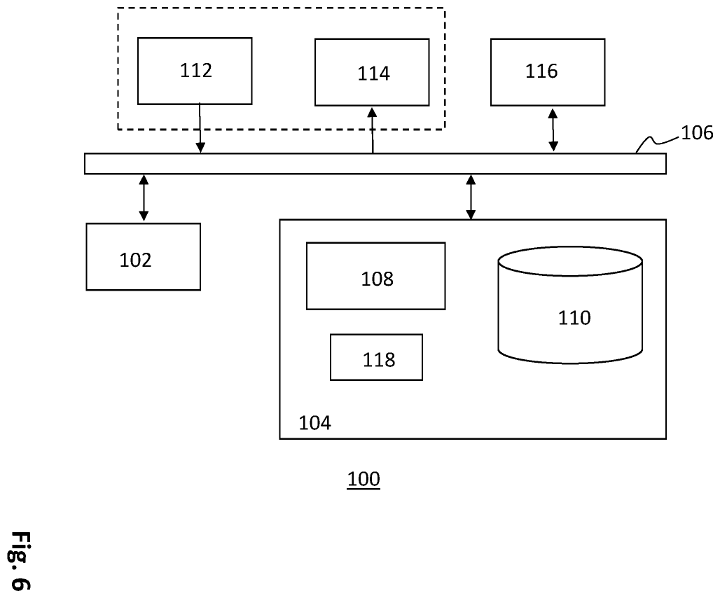

FIG. 6 depicts a block diagram illustrating a data processing system according to an embodiment.

As shown in FIG. 6, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 6 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 6, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 6) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

In one aspect of the present invention, the data processing system 100 may represent a central control system as described herein, or any other data processing system, such as data processing systems of BRPs.

In another aspect, the data processing system 100 may represent a client data processing system. In that case, the application 118 may represent a client application that, when executed, configures the data processing system 100 to perform the various functions described herein with reference to a “client”. Examples of a client can include, but are not limited to, a personal computer, a portable computer, a mobile phone, or the like.

In yet another aspect, the data processing system 100 may represent a server. For example, the data processing system may represent an (HTTP) server, in which case the application 118, when executed, may configure the data processing system to perform (HTTP) server operations.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method for controlling an amount of charging resources available to a plurality of electric vehicle supply equipment's; (EVSEs) connected to a power grid, the method comprising
receiving, from each of the plurality of EVSEs, data representing one or more actual charging profiles of respective one or more charging sessions, each said actual charging profile indicating for its said charging session a plurality of values indicative of an amount of consumed charging resources at respective times during the charging session ranging from an actual charging session start time to an actual charging session end time, each said actual charging profile being indicative of a total amount of energy provided to an electric vehicle during the charging session associated with the actual charging profile,
for each said actual charging profile, determining a fictitious charging profile associated with a fictitious charging session based on the actual charging profile, the fictitious charging profile being indicative of the total amount of energy provided during the charging session associated with that actual charging profile and the fictitious charging profile being indicative of an amount of fictitious consumed charging resources at respective times during the fictitious charging session ranging from a fictitious charging session start time to a fictitious charging session end time, wherein at least one said fictitious charging session is shorter than its associated said actual charging session, and
based on the determined fictitious charging profiles, predicting a total amount of required charging resources at a future time for the plurality of EVSEs.

2. The method according to claim 1, further comprising causing said predicted total amount of required charging resources to be available for the plurality of EVSEs at the future time.

3. The method according to claim 2, wherein said causing said predicted total amount of required charging resources to be available for the plurality of EVSEs at the future time comprises sending a request for the predicted total amount of charging resources to a balance responsible party and/or energy supplier.

4. The method according to claim 1, wherein the step of predicting, based on the determined fictitious charging profiles, the total amount of required charging resources at the future time for the plurality of EVSEs comprises
based on the determined fictitious charging profiles, determining an aggregate fictitious charging profile, and
based on the aggregate fictitious charging profile, predicting said total amount of required charging resources at the future time for the plurality of EVSEs.

5. The method according to claim 4, wherein determining the aggregate charging profile based on the fictitious charging profiles comprises determining, for each time out of a plurality of times, a sum of values that are indicated by the respective fictitious charging profiles for that time.

6. The method according to claim 1, wherein said at least one fictitious charging profile indicates a substantially constant value indicative of a fictitious amount of consumed charging resources during the fictitious charging session.

7. The method according to claim 6, wherein said substantially constant value is substantially equal to a maximum value out of said plurality of values indicated by the actual charging profile in question.

8. The method according to claim 6, wherein
each EVSE is suitable for imposing a limit on the amount of charging resources that it provides to an electric vehicle charging with it, and wherein
for each actual charging profile, the substantially constant value is substantially equal to a value out of said plurality of values which indicates an amount of consumed charging resources at a time at which the EVSE did not impose a limit on the amount of charging resources that it provides.

9. The method according to claim 6, wherein a length of the fictitious charging session is a difference between the fictitious charging session start time and fictitious charging session end time, and said length is substantially equal to a ratio between (i) the total amount of energy provided during the charging session and (ii) said substantially constant value.

10. The method according to claim 1, wherein the fictitious charging session start time and the actual charging session start time are substantially the same and/or wherein the fictitious charging session end time and the actual charging session end time are substantially the same and/or wherein the fictitious charging session start time lies between the actual charging session start time and the actual charging session end time and/or wherein the fictitious charging session end time lies between the actual charging session start time and the actual charging session end time.

11. The method according to claim 1, further comprising
receiving a request for an amount of charging resources to be provided at the future time, and
based on the request and based on the available charging resource for the plurality of EVSEs at the future time, causing one or more of said EVSEs to impose a limit on the amount of charging resources that is provided to one or more of said electric vehicles at the future time.

12. The method according to claim 11, wherein the step of causing the one or more EVSEs to impose the limit on the amount of charging resources that they provide to the one or more said electric vehicles at the future time frees up the requested amount of charging resources in said power grid for said future time.

13. A data processing system comprising means for performing the method according to claim 1.

14. A computer program comprising instructions which, when the program is executed by a computer, cause the computer to carry out the method according to claim 1.

15. A non-transitory computer-readable storage medium having stored thereon the computer program according to claim 14.

16. The method according to claim 3, wherein the step of predicting, based on the determined fictitious charging profiles, the total amount of required charging resources at the future time for the plurality of EVSEs comprises
based on the determined fictitious charging profiles, determining an aggregate fictitious charging profile, and
based on the aggregate fictitious charging profile, predicting said total amount of required charging resources at the future time for the plurality of EVSEs.

17. The method according to claim 16, wherein determining the aggregate charging profile based on the fictitious charging profiles comprises determining, for each time out of a plurality of times, a sum of values that are indicated by the respective fictitious charging profiles for that time.

18. The method according to claim 17, wherein said at least one fictitious charging profile indicates a substantially constant value indicative of a fictitious amount of consumed charging resources during the fictitious charging session and said substantially constant value is substantially equal to a maximum value out of said plurality of values indicated by the actual charging profile in question.

19. The method according to claim 18, wherein
each EVSE is suitable for imposing a limit on the amount of charging resources that it provides to an electric vehicle charging with it, and wherein
for each actual charging profile, the substantially constant value is substantially equal to a value out of said plurality of values which indicates an amount of consumed charging resources at a time at which the EVSE did not impose a limit on the amount of charging resources that it provides.

20. The method according to claim 10, wherein a length of the fictitious charging session is a difference between the fictitious charging session start time and fictitious charging session end time, and said length is substantially equal to a ratio between (i) the total amount of energy provided during the charging session and (ii) said substantially constant value.
